(19) United States
(12) Patent Application Publication
(10) Pub. No.: US 2009/0190704 A1
(43) Pub. Date: Jul. 30, 2009

(54) Synchronization of frame signals having two synchronization words

(75) Inventors: Moshe Ben-Ari, Givataim (IL); Moshe Twitto, Givat Shmuel (IL); Shay Landis, Hod-HaSharon (IL)

Correspondence Address: MARTIN D. MOYNIHAN d/b/a PRTSI, INC., P.O. BOX 16446, ARLINGTON, VA, 22215, US

(73) Assignee: Horizon Semiconductors Ltd., Herzlia (IL)

(21) Appl. No.: 12/010,397

(22) Filed: Jan. 24, 2008

(51) Int. Cl. H04L 7/00

(52) U.S. Cl. 375/365

(57) ABSTRACT

Apparatus for frame synchronization in a broadcast receiver where received frames comprise first and second synchronization words at predetermined locations in the frame, comprises: a correlator set with expected synchronization words for correlation with incoming symbols of said frame, to find probable locations of the first and second synchronization words within the frame, and a thresholder for thresholding the correlation according to both the first and second thresholds, thereby to allow, the receiver to synchronize with the frame.

### FIELD AND BACKGROUND OF THE INVENTION

The present invention, in some embodiments thereof, relates to serial data communication receivers generally and, more particularly, to a methodology for synchronization of frames having two synchronization words. More particularly but not exclusively there is provided simultaneous synchronizing of frames and super frames, and not exclusively, the embodiments relate to frames and super frames of an Integrated Services Digital Broadcasting for Satellite (ISDB-S) system.

Communication systems may work serially, that is—transmitting one bit at a time. The bits may also be modulated into symbols, and the modulated symbols may then be transmitted serially, one symbol at a time. Groups of such symbols are called frames, where each group is usually of the same length. Each group may begin or end with a predetermined code word, usually called the “sync word” or “unique word”. Various other operations may need to be performed on certain bits in the frame, and these bits are identified from the frame's internal organization prior to transmission. Such other operations include Forward Error Correction (FEC) encoding, interleaving, randomization and control data insertion. Since the relevant bits are identified by their position in the frame, a receiver of such transmitted data must first detect the attached sync words and synchronize the data according to them in order to be able to decode the FEC encoding and extract the original bits. Such an operation is known as frame synchronization.

Some systems, such as Integrated Services Digital Broadcasting for Satellite (ISDB-S), may group several frames together into a larger grouping called a super frame, and may also mark the super frame with a unique word. The operation of detecting the unique words over the super frame and synchronizing the data according to them is called super frame synchronization. The product of the frame synchronization and super frame synchronization operation may be the same serial

After the index of the last symbol of W3 14, also being the index of the last symbol of W2 13 for every eighth frame, has been detected, the circuit 200 may carry out the following computations only on the specific index found and simply test the correlation for increasing reliability of frame synchronization and also for lock of the super frame synchronization. Reliability testing following achievement of synchronization may be carried out using the Threshold Detector (TD) 240. TD 240 may start its processing only after initial frame lock. The TD 240 may compare the correlation at the discussed index with two different thresholds—TH1 and TH2, where TH1>TH2. Frames which are not the first frame of a super frame, that is—which contain the unique word W3 14 and not W2 13—are expected to have a high correlation value at the detected index, and thus a high threshold TH1 passing indicates positive detection of frame sync, in other words a frame synchronization hit. Not passing the threshold may be considered a frame synchronization miss. On the other hand, frames which are actually the first frame of a super frame, which contain the sync word W2 13, are expected to have very low correlation values in coherent correlation mode, in fact zero correlation for noise free and zero frequency shift conditions, due to the cancellation between W1 12 and W2 13. Thus, a correlation value less than a low threshold TH2 indicates a positive detection of super frame sync, or a hit. Crossing TH2 may be considered a miss.

Using higher values of TH1 and lower values of TH2 may increase the reliability of detection of frame sync or super frame sync, respectively, though it may also cause detection misses. For that reason, the TH1 and TH2, which are system parameters, may be adjusted according to the working conditions of the system (for example—SNR), and may be passed to the TD 240 from the LU 210 using the control signal 204. The hit or miss for frame sync and super frame sync may be passed to the LU 210 using the control signal 205.

A scoring mechanism may be used by the LU 210 for increasing the reliability of detection—one counter, for frame sync, may be increased for each frame sync hit and decreased for each frame sync miss, and a second counter for super frame sync may also be increased or decreased according to super frame sync hit or miss, respectively. Those two counters may be called frame_sync_score and super_frame_sync_score. input data, however accompanied by signals indicating the first bits of the frame and super frame, respectively.

The structure of an Integrated Services Digital Broadcasting for Satellite (ISDB-S) system super frame is described in FIG. 1. Each super frame is constructed of 8 frames, where each frame contains two unique words or synchronization words. The first frame 10 of a super frame contains the unique word W1 12 at the beginning of the frame, and the unique word W2 13 is at a constant bit distance from W1 12. The second frame 11 of a super frame contains the unique word W1 12 at the beginning of the frame, and the unique word W3 14 in constant bits distance from W1 12. The remaining 6 frames of the super frame has the same structure as the second frame 11, that is—contain the unique words W1 12 and W3 14. The use of unique words W2 13 in the first frame in contrast to the use of W3 14 in the other frames is designed to help detection of the start of a super frame. The length of all three unique words is the same.

A straightforward implementation of a synchronization mechanism may use only the detection of the unique word W1 12 for frame synchronization, and the use of the word W2 13 and/or W3 14 for super frame synchronization. Such an implementation may suffer from the disadvantage of long synchronization time due to the two phases that must be passed before achieving both the frame and super frame synchronizations. A further disadvantage is the low reliability of detection in low SNR, since a detection miss may occur due to the short length of the unique words. Moreover, a false hit detection may also occur, that is—a random combination of bits, say in the frame content or payload, may be similar to one of the unique words and be misinterpreted as the unique word. Another disadvantage may include the need for separate hardware for frame synchronization and super frame synchronization. Thus, a solution is needed for achieving synchronization in a shorter time with higher synchronization reliability, and using fewer hardware components.

In order to overcome synchronization problems, U.S. Pat. No. 7,308,064 teaches a frame synchronization method based on differential correlation information in a satellite communication system such as DVB-S, and particularly DVB-S2. The disclosure teaches a frame synchronization method for synchronizing frames with pilot blocks added thereto based on differential correlation information in the satellite communication system. The method can acquire a highly reliable frame synchronization estimation value by achieving a multi-step threshold value test using pilot blocks after a correlation analysis and a threshold test based on a sync signal in order to resolve the problem of a low signal-to-noise ratio and a large frequency error and acquire highly reliable frame synchronization performance, and can overcome distortion of a correlation analysis value caused by the frequency error by analyzing correlation based on differential information. The method includes the steps of:

a) performing correlation analysis and a threshold test by using a sync word in the correlator; and

b) performing a multi-step correlation value test by using pilot blocks added to the frames prior to the sync word.

However ISDB-S only has very short and non-mandatory pilot blocks for insertion into the transmission frames. Such short pilot blocks do not add much at low SNR even if they are present. Furthermore DVB-S does not have super frames.

U.S. Pat. No. 6,625,463 concerns synchronization of super frames in ISDB-S. As mentioned, ISDB-S has synchronization word W1 at a certain location in all frames and then has either of W2 or W3 at a second location to indicate either a regular frame or a super frame. A dedicated circuit is provided to detect the synchronization word at the second location and decide whether it is W2 or W3, and therefore whether the current frame is the start of a super frame or not. The result is a very short synchronization word. Furthermore, the correlation is hard, meaning made over detected bits, and does not relate to symbols.

### SUMMARY OF THE INVENTION

The present invention in some of its embodiments relates to the use of correlation on two unique or synchronization words in a frame to carry out frame synchronization. The synchronization on the two words may be coherent and may additionally allow to synchronize to super frames. In a preferred embodiment there is provided simultaneous synchronization to frames and super frames.

In an alternative embodiment non-coherent synchronization is provided to the two words. Non-coherent synchronization is useful during frequency drift but may not provide super frame synchronization. If the frequency drift can be slowed down or stopped then the system may move to coherent synchronization and super frame synchronization may be attained.

The present embodiments are particularly suitable for ISDB-S, but can be used for synchronizing to any frames that have two synchronization words.

According to an aspect of some embodiments of the present invention there is provided apparatus for frame synchronization in a broadcast receiver where received frames comprise first and second synchronization words at predetermined locations in the frame, the apparatus comprising:

a correlator set with expected synchronization words for correlation with incoming symbols of the frame, to find probable locations of the first and second synchronization words within the frame, and

a thresholder for thresholding the correlation according to both the first and second synchronization words, thereby to allow the receiver to synchronize with the frame.

In an embodiment, the thresholder is associated with a maximizer configured to determine index positions giving maximum correlation values over a series of frame lengths.

In an embodiment, the second synchronization word takes first and second values within the frames depending on whether a given frame is a first frame of a super frame or not, the second value being a complement of the first value so as to give minimal correlation when the first value gives maximal correlation, the thresholder being set with an upper threshold to recognize the maximal value and a lower threshold to recognize the minimal value, thereby to distinguish using correlation between frames and super frames, and allow the apparatus to further synchronize with the super frames.

In an embodiment, the correlator is a non-coherent correlator configured to calculate separate correlations for each of the first and second word, taking into account a time delay therebetween, and to add the separate correlations.

In an embodiment, the correlator is a coherent correlator, configured to compute a single correlation result from both of the first and second words together, taking into account the time delay between them.

In an embodiment, the correlator is controllably configurable via a control signal to be either a non-coherent correlator, configured to calculate separate correlations for each of the first and second word, taking into account a time delay therebetween, and to add the separate correlations, or a coherent correlator, configured to compute a single correlation result from both of the first and second words together, taking into account the time delay between them.

An embodiment may comprise a frequency lock loop circuit, and wherein during a frequency shift condition, the control signal is usable to switch the correlator between an initial non-coherent state wherein the frequency lock loop circuit operates to reduce the frequency shift, and a subsequent coherent state.

An embodiment may comprise a frame counter and a super frame counter, the frame counter for incrementing when an expected frame synchronization is confirmed and decremented when an expected frame synchronization is missed, and the super frame counter for incrementing when an expected super frame synchronization is confirmed and decremented when an expected super frame synchronization is missed, thereby to provide numerical indicators of a current reliability of synchronization.

In an embodiment, the maximizer is configured to generate a control signal holding a symbol index in response to a correlation result.

An embodiment may comprise a synchronization flag inserter, configured to inject, to the input signal, frame sync and super frame sync flags, therewith to allow the apparatus to synchronize with the frames and the super frames.

In an embodiment, the frames are frames according to the Integrated Services Digital Broadcasting for Satellite (ISDB-S) system, each containing first and second synchronization words of 20 symbols with a predetermined distance between them.

In an embodiment, the maximizer is configured to determine an index with a maximum correlation value over a series of constant frame lengths over the input data, the series comprising a predetermined number of frame lengths.

An embodiment may comprise a control input to the thresholder to define for the thresholder the predetermined number.

In an embodiment, the thresholder compares a correlation value to a first threshold and a second threshold, and produce a HIT and MISS signals for each threshold.

In an embodiment, the frame counter is configured to produce an increment if the correlation value crosses the first threshold, and a decrement otherwise, and the super frame counter is configured to produce a decrement if crossing the second threshold and an increment otherwise.

In an embodiment, the counter comparison is carried out only when an input index equals an index reported by the thresholder.

An embodiment may comprise a control input for setting the first and second thresholds.

In an embodiment, the flag inserter is configured to set an output frame sync flag to one at the index of a first symbol of each frame and reset at any other index.

In an embodiment, the flag inserter is configured to set an output super frame sync flag to one at the index of the first symbol of each super frame and reset at any other index.

An embodiment may comprise calculating an index of the first symbol of each frame by subtracting the predetermined length from an output index of the thresholder circuit, the output index being an index of the last symbol of the second unique word.

In an embodiment, the flag inserter is configured to produce respective output frame sync flags and super frame sync flags in response to the HIT and MISS signals from the counters and maximum frame and super frame synchronization score parameters.

In an embodiment, the non-coherent correlator is configured to calculate a non-coherent correlation according to:

$${R}_{n} = {( {\sum }_{i = 0}^{19} {SI}_{n - i - 160} \cdot W {1}_{19 - i} )}^{2} + {( {\sum }_{i = 0}^{19} {SQ}_{n - i - 160} \cdot W {1}_{19 - i} )}^{2} + {( {\sum }_{i = 0}^{19} {SI}_{n - i} \cdot W {3}_{19 - i} )}^{2} + {( {\sum }_{i = 0}^{19} {SQ}_{n - i} \cdot W {3}_{19 - i} )}^{2}$$

Where SIₙ comprises the in-phase component of the n^{th} input symbol, SQₙ comprises the quadrature component of the n^{th} input symbol, W1ₙ comprises the n^{th} BPSK modulated value of the first unique word, and W3ₙ comprises the n^{th} BPSK modulated value of the second unique value of the second unique word.

In an embodiment, the coherent correlator is configured to calculate the coherent correlation according to:

$${R}_{n} = {( {\sum }_{i = 0}^{19} {SI}_{n - i - 160} \cdot W {1}_{19 - i} + {\sum }_{i = 0}^{19} {SI}_{n - i} \cdot W {3}_{19 - i} )}^{2} + {( {\sum }_{i = 0}^{19} {SQ}_{n - i - 160} \cdot W {1}_{19 - i} + {\sum }_{i = 0}^{19} {SQ}_{n - i} \cdot W {3}_{19 - i} )}^{2}$$

Where SIₙ comprises an in-phase component of the n^{th} input symbol, SQₙ comprises the quadrature component of the n^{th} input symbol, W1ₙ comprises the n^{th} BPSK modulated value of the first unique word, and W3ₙ comprises the n^{th} BPSK modulated value of the second unique value of the second unique word.

According to a second aspect of the present invention there is provided a method for frame synchronization in a broadcast receiver where received frames comprise first and second synchronization words at predetermined locations in the frame, the method comprising:

using expected synchronization words for correlation with incoming symbols of the frame, to find probable locations of the first and second synchronization words within the frame, and

thresholding the correlation according to both the first and second synchronization words, thereby to allow the receiver to synchronize with the frame.

An embodiment may comprise calculating separate correlations for each of the first and second word, taking into account a time delay therebetween, and adding the separate correlations.

An embodiment may comprise computing a single correlation result from both of the first and second words together, taking into account the time delay between them.

In an embodiment, the correlating is controllably configurable via a control signal to be either non-coherent correlating, comprising calculating separate correlations for each of the first and second word, taking into account a time delay therebetween, and adding the separate correlations, or coherent correlating, comprising computing a single correlation result from both of the first and second words together, taking into account the time delay between them.

An embodiment may comprise, during a frequency shift condition, switching the correlating between an initial non-coherent state and a subsequent coherent state.

An embodiment may involve using frequency locking during the coherent state to reduce the frequency shift to allow commencement of the coherent state.

In an embodiment, the coherent correlation comprises:

initializing to coherent correlation after determining an index of the symbol having the maximum correlation value over a frame, Iₘₐₓ (“initial lock”);

Initializing frame_counter, frame_sync_score, super_frame_sync_score and super_frame_sync_lock parameters to zero;

Checking if the super_frame_sync_lock equals zero and if frame_counter is less than 2:

if so—checking if the correlation value is smaller than a second threshold:

If so—increasing the super_frame_sync_score by one and setting the frame_counter to one.

If not—setting super_frame_sync_score to zero and setting frame_counter to zero;

If the super_frame_sync_score equals MAX_SFSS then setting super_frame_sync_lock to one;

Checking if the correlation value is greater than first threshold:

If so—increasing frame_sync_score by one, and if the resulting new value of frame_sync_score is greater than MAX_FSS then setting frame_sync_score to MAX_FSS,

If the correlation value is not greater then the first threshold—checking if super_frame_sync_lock equals one and frame_counter also equals one:

If either super_frame_sync_lock or frame_counter do not equal one then—decreasing frame_sync_score by one and checking if the new value of frame_sync_score equals zero;

if the frame_sync_score equals zero then declaring that lock has been lost and resetting the process;

Checking if the frame_counter is greater than zero:

If the frame-counter is greater than zero then—increasing the frame_counter by one; if the frame_counter is greater than eight then setting the frame_counter to one; and

returning to check the next correlation value against the first threshold.

In an embodiment, the correlation comprises: initializing the correlation state after determining the index of the symbol having the maximum correlation value over a frame, Iₘₐₓ (“initial lock”);

Initializing a frame_sync_score to zero;

checking if a current correlation value is greater than a first threshold:

If so—increasing frame_sync_score by one, and if a resulting value of frame_sync_score is greater than MAX_FSS then setting frame_sync_score to MAX_FSS;

If the current correlation value is less than the first threshold—decreasing the frame_sync_score by one and checking if the new value of frame_sync_score equals zero, thereby to reset the process; and otherwise returning to check the following correlation value against the first threshold.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagram illustrating an Integrated Services Digital Broadcasting for Satellite (ISDB-S) system super frame.

FIG. 2 is a block diagram of a first embodiment of the present invention.

FIG. 3 is a diagram illustrating the first embodiment of the correlator of the present invention in a coherent configuration.

FIG. 4 is a diagram illustrating the first embodiment of the correlator of the present invention in a non-coherent configuration.

FIG. 5 is a flowchart diagram illustrating the preferred embodiment of the logic for simultaneous frame and super frame synchronization of the present invention in its coherent configuration.

FIG. 6 is a simplified flow chart showing frame synchronization in the non-coherent configuration.

### DESCRIPTION OF EMBODIMENTS OF THE INVENTION

The present invention, in some embodiments thereof, relates to serial data communication receivers generally and, more particularly, to a methodology for synchronization of frames having two synchronization words. More particularly but not exclusively there is provided simultaneous synchronizing of frames and super frames, and not exclusively, the embodiments relate to frames and super frames of an Integrated Services Digital Broadcasting for Satellite (ISDB-S) system.

The present embodiments provide an apparatus comprising a correlator, a maximum detector, a thresholder and counters and flag inserting circuits. The correlator may calculate the correlation between the input data to the apparatus and prestored versions of two unique words, these words being the synchronization words. The maximum detector may search for the index with the maximum value of the correlation signal. The thresholder may compare the correlation signal to two thresholds and report hits and misses. The counter and flag inserter circuit is a logic unit that may set the parameters of the correlator, maximum detector and thresholder. The embodiments may jointly track the first index of a frame and the first index of a super frame. Other services such as counting, to provide synchronization reliability etc, may also be provided by the logic unit, as is described below.

The objects, features and advantages of the present invention include a method of simultaneously synchronizing frames and super frames in an Integrated Services Digital Broadcasting for Satellite (ISDB-S) system that may detect the combination of two unique words, reduce the probability of false lock, reduce the probability of losing a synchronization lock, and use less hardware for achieving both frame and super frame synchronization.

There is further provided a method of frame synchronization that may increase the synchronization lock probability and reliability in a high frequency shift condition. This may be achieved by starting with non-coherent correlation of the two synchronization words until frequency shift is reduced and then moving to coherent correlation.

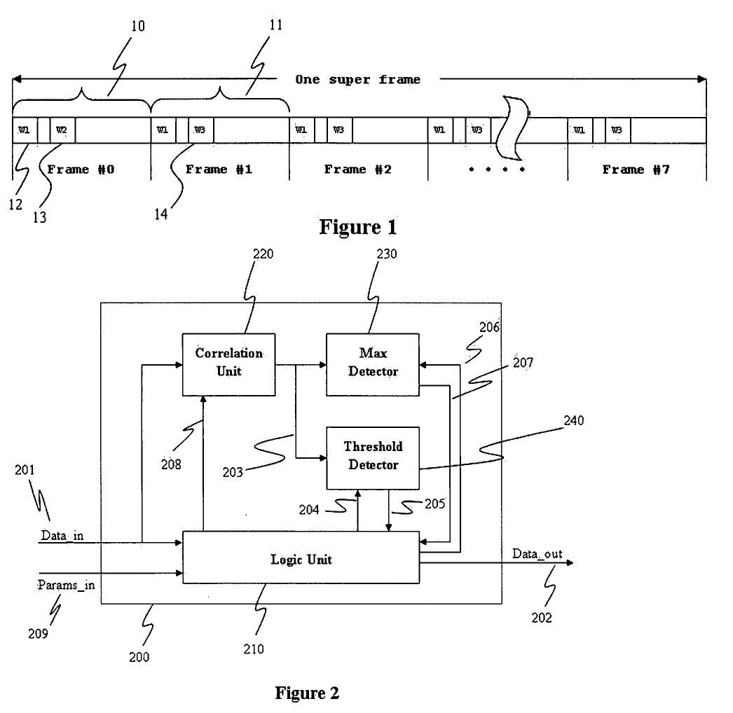

For purposes of better understanding some embodiments of the present invention, as illustrated in FIGS. 2-6 of the drawings, reference has been made above to FIG. 1 to describe a conventional super frame sequence, with individual frames shown therein. As explained, FIG. 1 shows a single super frame of which a first frame #0 which has synchronization words W1 and W2. A second frame #1 has synchronization words W1 and W3, and all subsequent frames in the super frame also have words W1 and W3. W3 is the complement of W2 according to the ISDB-S standard.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Referring now to FIG. 2, apparatus 200 provides frame synchronization in a broadcast receiver where received frames include first and second synchronization words at predetermined locations in the frame as per FIG. 1.

The apparatus comprises a correlation unit 220 which is set with expected synchronization words which it uses for correlation with incoming symbols of the apparatus. Based on the result of the correlation it is possible to find probable locations or an index, of the first and second synchronization words within an incoming frame.

Any length of bits produces some results out of a correlator. The stronger the result the more likely that the incoming signal correlates with the signal being looked for, and the strongest correlation index implies of the location of the synchronization words in the input signal. Maximum detector 230 finds the index location which gives the maximum correlation over a series of frames. A thresholder 240 thresholds the correlation of the combination of both the first and second synchronization words, at an index, that is a location within the frame, of the synchronization words pointed to by the maximum detection. Thus the receiver is able to synchronize with the incoming frame sequence.

Since the frame lengths are fixed, an expected location of the next synchronization word is apparent. The system can thus look ahead to that location and provide a correct location of the first symbol of the first synchronization word based on the detected location of the last symbol of the second synchronization word.

As mentioned above the second synchronization word takes two different values depending on whether the frame is the first in a super frame or not. The two values may be complementary, so that the same coherent correlation function can be used to detect either, one giving a result of 1 and the other giving a result of 0. General frame content, being neither the wanted signal nor its complement, tends to give results in the middle of the 0-1 range. Of course in real life with noise in the system, actual 1s and 0s are not achieved, but suitable thresholding can be used to identify correlations.

Thus the coherent correlation operation on the synchronization word takes upper and lower values in any given frame depending on whether a given frame is the first frame of a super frame or not.

The identification of the beginning of a super frame in this way, so that the system simultaneously synchronizes to both frames and super frames, means that by correlating to two synchronization words a longer synchronization length is used, and instantaneous noise therefore has less effect on synchronization.

In the following, two methods of carrying out the correlation are introduced, one is referred to hereinafter as coherent correlation and the other is referred to as non-coherent correlation. Taking the non-coherent case first, separate correlations are made for the first and second synchronization words respectively. The time delay between them is taken into account and then the two correlation results are added together to produce an overall result.

In the coherent case, a coherent correlator computes a single correlation result from both of the synchronization words, again of course taking into account the time delay between them.

In one embodiment, a single correlator is controlled by a control signal to be either a non-coherent correlator or a coherent correlator, and thus to alternate between a single correlation function for both words and two separate functions for the two separate words.

The apparatus may comprise a frame counter and a super frame counter. The frame counter increments whenever an expected frame synchronization is confirmed, and is decremented when an expected frame synchronization is missed. The super frame counter is incremented whenever an expected super frame synchronization is confirmed and decremented when an expected super frame synchronization is missed. The current readings of the two separate counters may provide numerical indicators of the current reliability level of the synchronization, as will be explained in greater detail below.

FIG. 2 is now considered in greater detail. FIG. 2 shows a block diagram of a circuit 200 which is a synchronization unit in accordance with a preferred embodiment of the present invention. The circuit 200 may be implemented as a frame and super frame synchronization circuit, that may be a part of a serial data transmission receiver. Data_in 201 is input to the circuit 200. Data_in 201 may comprise symbols of one or more Integrated Services Digital Broadcasting for Satellite (ISDB-S) system super frames. The output of the circuit 200, the signal Data_out 202 may be the same serial data entering the circuit 200 (Data_in 201) accompanied by synchronization signals marking the first symbol of frame and super frame. The circuit 200 may also comprise a Correlation Unit (CU) 220 that may be configured to calculate the correlation between the Data_in signal 201 and a known sequence of data that may be comprised of the transmission system unique words, in other words the data of the correlation function. The circuit 200 may also comprise a Max Detector (MD) 230 that may find the index over the input signal with a length of one frame in which the correlation is maximal over the given frame. Such an index gives a first indication as to the correct synchronization. The circuit 200 may also comprise a Threshold Detector (TD) 240 that may be configured to compare the correlation per input symbol to predetermined thresholds and produce a binary signal indicating threshold cross information. The circuit 200 may also comprise a Logic Unit (LU) 210 to manage the operation of the circuit 200, inter alia counting the input data symbols of Data_in 201.

The circuit 200 may also provide a first internal data signal 203 to provide the output of the Correlation Unit (CU) 220. The output of the correlation unit is the correlation value of each input symbol, and may in turn provide the input to the Max Detector (MD) 230 and the Threshold Detector (TD) 240.

The circuit 200 may also comprise a second internal control signal 204 which is output from the Logic Unit (LU) 210 and provided as an input to the Threshold Detector (TD) 240. This second internal control signal may be used to configure the operation of the Threshold Detector (TD) 240.

The circuit 200 may also comprise a third internal control signal 206 output from the Logic Unit (LU) 210 and provided as input to the Maximum Detector (MD) 230, that may be used to configure operation of the Maximum Detector (MD) 230.

The circuit 200 may also comprise a fourth control signal 207 output by the Maximum Detector (MD) 230 and provided as an input to the Logic Unit (LU) 210. This fourth signal may comprise the index of the symbol having the largest correlation value as determined by the synchronization operation.

The circuit 200 may also comprise a fifth internal control signal 205 which is output from the Threshold Detector (TD) 240 and provided as an input to the Logic Unit (LU) 210. This fifth internal control signal may comprise data related to hits and misses of the TD 240.

The circuit 200 may also comprise of a sixth internal control signal 208, which consist of the output of the Logic Unit (LU) 210. The signal is input to the Correlation Unit (CU) 220, and may used to control the operation mode of the Correlation Unit (CU) 220.

The circuit 200 may also comprise an external control signal, Params_in 209, holding all the parameters values of circuit 200.

The structure of an Integrated Services Digital Broadcasting for Satellite (ISDB-S) system super frame is described in FIG. 1, referred to above. Each super frame is comprised of 8 frames, each containing 39,936 symbols, and thus the whole super frame is constructed of 319,488 symbols. Each frame contains two sync words—sync word W1 12 at the beginning of the frame and sync word W2 13 for the first frame of each super frame or W3 14 for all other seven frames of a super frame, at a distance of 128 symbols from the end of sync word W1 12. The sync words W2 13 and W3 14 are the digital complements to each other, that is: W2= W̅3̅. Each sync word is comprised of 16 bits, encoded by a ½ rate convolution encoder with a constraint length of 7 and BPSK modulation, and thus each symbol code word is comprised of 32 BPSK modulated symbols. Since the convolution encoder does not terminate its operation in a known state before encoding each sync word, the first 12 bits at the output of the convolution encoder are dependent on the memory of the encoder when feeding the encoder with a sync word, and thus only 20 bits at the encoder output are fully known and available for detection of a sync word.

The Correlation Unit (CU) 220 may be the unit calculating the correlation between the input signal (Data_in 201) and the searched sequence of symbols. A correlation Rₙ between sequential arriving symbols, Sₙ, and a known series of 20 symbols, a₀, . . . , a₁₉ may be expressed by the formula:

$${R}_{n} = {\vert {\sum }_{i = 0}^{19} {S}_{n + i} \cdot {a}_{i}^{*} \vert}^{2} = {\vert {\sum }_{i = 0}^{19} {S}_{n - i} \cdot {a}_{19 - i}^{*} \vert}^{2} \qquad ( 1 )$$

Sₙ may be comprised of in phase signal, Iₙ, and Π/2 phase shifted signal (quadrature), Qₙ, thus Sₙ=SIₙ+j·SQₙ, and the same for an: aₙ: aₙ=aIₙ+j·aQₙ. Since the known series aₙ is BPSK modulated, it has no imaginary component, and thus aₙ=aIₙ, and the formula becomes:

$${R}_{n} = {\vert {\sum }_{i = 0}^{19} ( {SI}_{n + i} + j \cdot {SQ}_{n + i} ) \cdot {aI}_{i} \vert}^{2} = {\vert {\sum }_{i = 0}^{19} ( {SI}_{n - i} + j \cdot {SQ}_{n - i} ) \cdot {aI}_{19 - i} \vert}^{2} \qquad ( 2 )$$

In one implementation, the CU 220 may calculate Rₙ of the input symbols for W1 12 in order to achieve frame synchronization, and separately calculate Rₙ of the input symbols for W2 13 and/or W3 14 to achieve super frame synchronization. This, however, may suffer from requiring a two phase synchronization and thus taking longer to achieve synchronization. Furthermore, there is an increased risk of detecting false sync words in the case of low SNR, due to the short sync words—just 20 symbols. Instead, the CU 220 may be configured to calculate the correlation of the combination of W1 12 and W3 14, that is—the correlation is now for a doubled size sync word. The combined correlation may be calculated in one of two ways, as discussed above:

non-coherently, where the correlation is calculated separately for W1 12 and W3 14 (with the time delay between them taken into account) and added, and

coherently, where the correlation is computed over both sync words together, again—taking into account the time delay between them.

After replacing aₙ with W1ₙ and W3ₙ and inserting the time delay between sync word W1 12 and sync word W3 14, the formula becomes (taking only the right side of the formula):

$${R}_{n} = {\vert {\sum }_{i = 0}^{19} ( {SI}_{n - i - 160} + j \cdot {SQ}_{n - i - 160} ) \cdot W {1}_{19 - i} \vert}^{2} + {\vert {\sum }_{i = 0}^{19} ( {SI}_{n - i} + j \cdot {SQ}_{n - i} ) \cdot W {3}_{19 - i} \vert}^{2} = {( {\sum }_{i = 0}^{19} {SI}_{n - i - 160} \cdot W {1}_{19 - i} )}^{2} + {( {\sum }_{i = 0}^{19} {SQ}_{n - i - 160} \cdot W {1}_{19 - i} )}^{2} + {( {\sum }_{i = 0}^{19} {SI}_{n - i} \cdot W {3}_{19 - i} )}^{2} + {( {\sum }_{i = 0}^{19} {SQ}_{n - i} \cdot W {3}_{19 - i} )}^{2} \qquad ( 3 )$$

for non-coherent correlation, and:

$${R}_{n} = {\vert {\sum }_{i = 0}^{19} ( {SI}_{n - i - 160} + j \cdot {SQ}_{n - i - 160} ) \cdot W {1}_{19 - i} + {\sum }_{i = 0}^{19} ( {SI}_{n - i} + j \cdot {SQ}_{n - i} ) \cdot W {3}_{19 - i} \vert}^{2} = {( {\sum }_{i = 0}^{19} {SI}_{n - i - 160} \cdot W {1}_{19 - i} + {\sum }_{i = 0}^{19} {SI}_{n - i} \cdot W {3}_{19 - i} )}^{2} + {( {\sum }_{i = 0}^{19} {SQ}_{n - i - 160} \cdot W {1}_{19 - i} + {\sum }_{i = 0}^{19} {SQ}_{n - i} \cdot W {3}_{19 - i} )}^{2} \qquad ( 4 )$$

for coherent correlation.

The coherent correlation has two main advantages over the non-coherent:

a. the resulting correlation for a real combination of the two sync words W1 12 and W3 14 is higher for noisy signal, assuming no frequency deviation of the signal or small frequency deviation; and

b. while for infinite SNR and real combination of the two sync words W1 12 and W3 14 the correlation values are very high at the correct symbols, for the combination of the two sync words W1 12 and W2 13 the correlation values are zero at the correct symbols, due to the fact that W2= W̅3̅ (the two expressions cancel each other). This fact allows simultaneous frame synchronization and super frame synchronization. The lower the SNRs the further the correlation values will be in practice from zero due to the noise preventing a full cancellation. Nevertheless the correlation values at the correct symbols will be essentially lower than for random points in the data.

The disadvantage of the coherent correlation methodology in respect to non-coherent correlation methodology appears when frequency deviation exists in the input data to the circuit 200—the frequency deviation causes a correlation loss since the symbols are not summed up coherently due to the frequency shift from symbol to symbol. While the symbol to symbol frequency deviation over the twenty symbols causes some losses, the accumulated frequency shift over the delayed 160 symbols may be much greater, even up to a point where full cancellation may appear between the first twenty symbols (of W1 12) and the twenty symbols of W3 14. Since the non-coherent methodology correlates the first twenty symbols separately from the next group of twenty symbols, any frequency deviation has less affect. Nevertheless, symbol to symbol frequency shift still causes some losses.

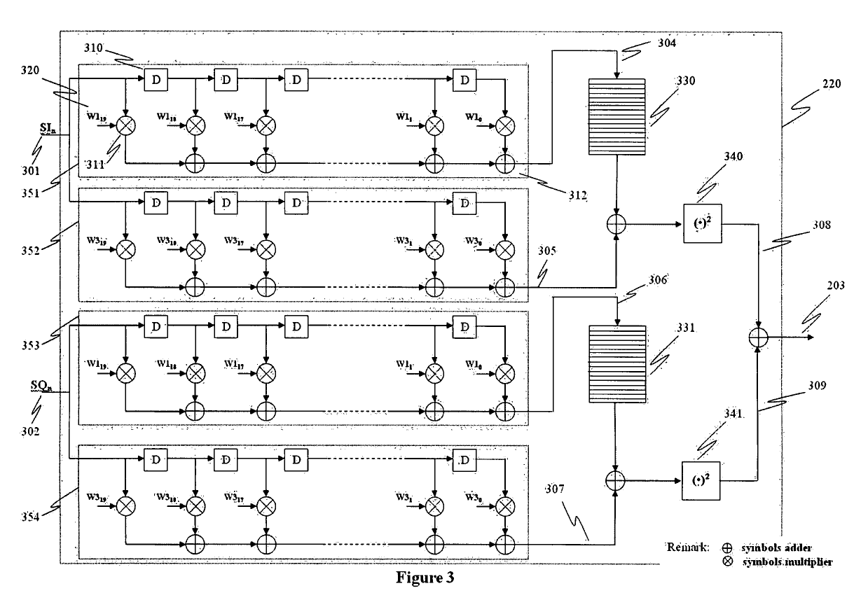

A possible implementation of the CU 220 in the coherent correlation mode is described in FIG. 3, to which reference is now made. The Data_in input 201 to the circuit 200 may be divided into SIₙ 301 and SQₙ 302, where Data_in=SIₙ+j·SQₙ. The SIₙ 301 input may be delayed in the circuit using twenty delay registers 310 so that the current twenty values of the input may be correlated to the predetermined sync word W1 12. The correlation may be made using multipliers 311 as illustrated in FIG. 3. It is noted that, since the sync words are BPSK modulated, each multiplier 311 may actually be implemented as a sign inverter, which may invert or not invert the symbol sign according to the matching bit of the sync word 320. The 20 multiplication results may then be summed using a set of adders 312. The above processing of the input data SIₙ 301 may be done twice, one using sync word W1 12 (over branch 351) and the other using sync word W3 14 (over branch 352). To satisfy (4), the upper branch outcome 304 may then be delayed for 160 symbols to match the distance between the arrival of W1 12 and W3 14. This may be done using a FIFO buffer 330, implemented for example by registers or a memory block. Branch 351 outcome 304 and branch 352 outcome 305 may be added and raised by the power of two using a squaring block 340. The product of this process 308 may comply with the first part of (4).

The same process may be carried out with the input data SQₙ 302, again with branch 353 producing product 306, and which is then delayed in respect of branch 354 which produces product 307. The delay is achieved using FIFO buffer 331 which has a symbol length of 160. The two products 306 and 307 are then added and squared using a squaring block 341, to produce a result 309.

The products 308 and 309 of the two square blocks 340 and 341 respectively may be added to produce a result in the output 203 of the CU 220, which complies with (4).

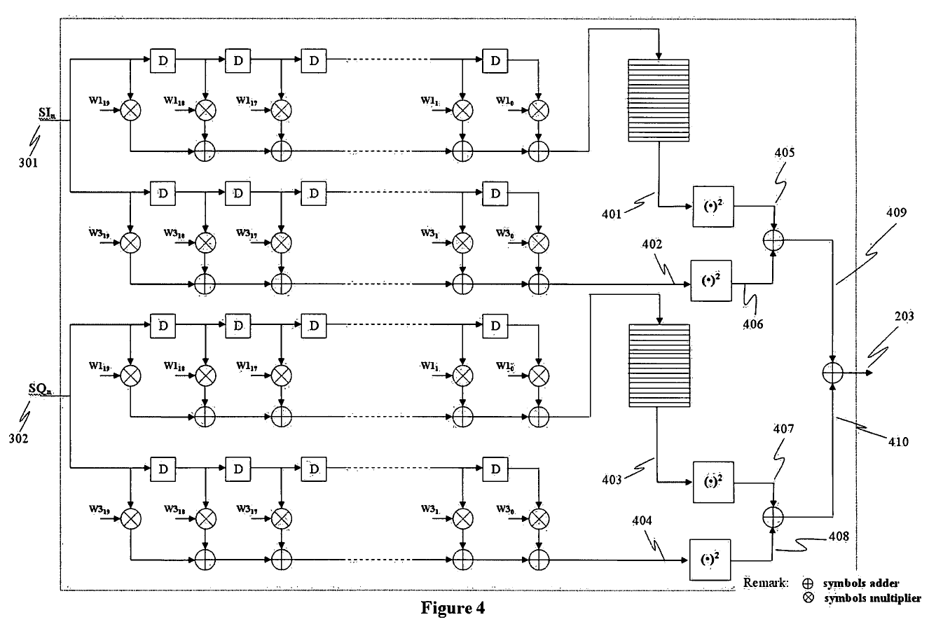

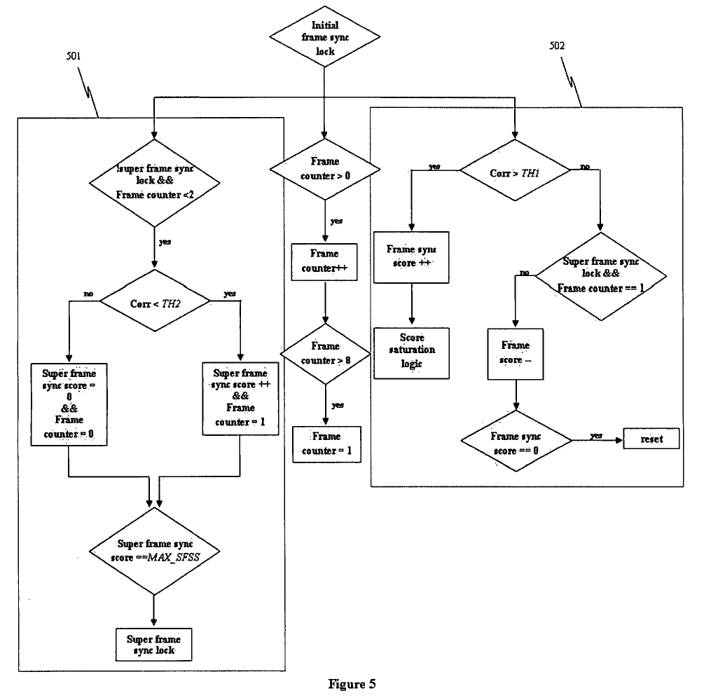

A possible implementation of the CU 220 in the non-coherent correlation mode is described in FIG. 4, to which reference is now made. The beginning of the processing of SIₙ 301 and SQₙ 302 may be the same as for the coherent mode, that is—correlating each of the input symbols with W1 12 and W3 14 and delaying the correlation product of the branch correlated with W1 12 for 160 symbols, though the second part of the processing may be different. To comply with the non-coherent formula (3), each of the four correlation components 401, 402, 403 and 404 must be separately squared, and the four outcomes of the four squaring operations—405, 406, 407, 408—may then be added to produce an overall output 203 for the correlator 220.

The CU 220 circuit may be programmable to switch between coherent and non-coherent modes and produce either a coherent correlation output according to FIG. 3 or a non-coherent correlation output, according to FIG. 4, depending on a command from the LU 210 through the control signal 208.

Referring back to FIG. 2, the CU 220 produces correlation output 203, which is the input into two separate detectors—the Max Detector (MD) 230 and the Threshold Detector (TD) 240. As circuit 200 is turned on, say on system reset, or after synchronization loss, when no information on the locations of the sync words in the frame is available, the MD 230 may be configured to search for a symbol index of maximum correlation by searching for the maximum correlation value over each consecutive 39,936 symbols (one frame length) The symbol corresponding to the maximum correlation is assumed to be the index which corresponds to the last symbol of sync word W3 14, which is the second sync word. The index of the first symbol of the frame, which is the first symbol of the sync word W1 12, may then be calculated by subtracting 191 from the index of the last symbol of the sync word W3 14. This is due to the fact that there are 128 symbols between the two sync words and each full sync word length is 32 symbols, according to the ISDB-S standard.

If the CU 220 is set for non-coherent correlation mode, and Data_in 201 is noise free and no frequency deviation exists, then the above assumption may be correct for each and every frame. However, if the CU 220 is configured to work in coherent correlation mode, then the assumption may only be correct for seven out of every eight frames. For the eighth frame however, which is the first frame of each super frame, the correlation value of the index which complies to the last symbol of sync word W3 14 will be zero, since the combination actually was transmitted was W1 12 and W2 13, and the correlation in fact cancels the signal since W2= W̅3̅. Thus, for the coherent correlation mode, there is a probability of ⅞ of detecting the sync words combination at any frame, in the above mentioned conditions.

If the input data is not noise free and/or some frequency shift does exist, there are further losses affecting the detection probability for both coherent and non-coherent modes. Thus, the MD 230 may be configured to detect the maximum correlation index over a few consecutive frames, and only after several detections of a maximum on the same index the MD 230 may decide that this is the correct index. The number of consecutive frames may be a parameter of the circuit 230 called max_consecutive_hits, and may be adjusted according to the conditions the system works in, that is conditions of SNR, frequency deviation, etc. The parameter max_consecutive_hits may be calculated by the LU 210 according to the current conditions and sent to the MD 230 via control signal 206. The phase involving acquiring the index of the last symbol of W2 13 or W3 14 may be called initial frame sync lock.

After the MD 230 has detected the index of the last symbol of the second sync word, it may send this information back to the Logic Unit (LU) 210, and the circuit 200 need not again use the MD 230 until sync lock is lost or the circuit is reset.

Since per each frame there may be a hit only for one of the combinations, that is—either frame sync or super frame sync, it is not desirable to keep a simple scoring track simultaneously for both frame sync and super frame sync, since no scoring decreasing is needed for frame sync (or super frame sync) miss if there is a super frame (or frame) hit. Thus, another counter, frame_counter, may be used to keep track of which kind of frame is expected—a frame which contains a super frame sync combination, that is—W1 12 and W2 13, or a frame that contains a frame sync combination—W1 12 and W3 14, and reference is now made to FIG. 5, which is a flow diagram that describes the logic for this purpose. This logic refers only to the phase after the initial frame sync lock, and to a correlation index that has already been marked as the one that should contain the relevant correlation values for hit/miss logic.

The logic is described in the flow chart of FIG. 5. The frame_counter may be initialized to zero, indicating no knowledge about which frame out of the eight frames of the super frame is currently handled. The left branch 501 of the flow chart describes the logic that may be used for super frame synchronization. It may be assumed that once a super frame sync has been detected, there is no need for further testing of super frame sync, and thus a flag called super_frame_sync_lock may be used. On the other hand, in either of the following two cases the super frame synchronization should be tested against TH2. The first is if no super frame sync lock has been announced yet, and only if the frame_counter equals zero that is there is as yet no knowledge on which frame within the super frame is current. The second case is when the frame_counter equals one, meaning this is a first frame in the super frame and thus super frame sync detection is expected on this frame. If the test is passed then super_frame_sync_score may be increased by one, and the frame_counter may be set to one, to indicate that this frame is the first in the super frame. Else, the LU 210 may assume this is not the first frame of the super frame and thus the frame_counter may be set to zero—meaning no knowledge about the number of the frame inside the super frame is available. Correspondingly, the super_frame_sync_score may be zeroed. The last phase of the branch 501 may involve comparing the super frame sync score to a parameter MAX_Super_Frame_Sync_Score (MAX_SFSS), which indicates the super frame sync score is high enough and super frame sync lock may be announced. MAX_SFSS may be adjusted according to the SNR and frequency deviation conditions of the system.

The right branch 502 of the flow chart describes the logic that may be used for frame synchronization. If the correlation value crosses TH1, it means a combination of the sync words W1 12 and W3 14 was detected, and the frame sync score may be increased. Also, if achieving a certain score, MAX_Frame_Sync_Score (MAX_FSS), the LU 210 may cut off further incrementation of the frame counter at this point, so it will not keep growing. This saturation logic may be necessary in order to prevent a very high score, which would then require a large number of frames to decrease back to zero when the system loses its synchronization, meaning—it would take many frames for the system to recognize the lost lock situation. The value of MAX_FSS may be adjustable by the LU 210 and be a trade off between sync lock reliability and speed of detecting a lock lost and relocking. If the correlation value does not cross TH1, meaning—the test has failed, then the frame sync score may be decreased, though only if the frame_counter does not equal one, indicating this frame is the first in the super frame and the correlation value is supposed to be low. If the frame sync score decreases down to zero, then it may be considered as a frame sync lock lost, and the system may be reset, and start the search for synchronization from the beginning.

Aside from the two branches 501 and 502, the frame_counter may be increased by one every frame cycle if it is already greater than zero, so as to indicate the frame number inside the super frame. If the frame counter equals zero there is no point in increasing it since there is no knowledge about which frame inside the super frame is currently being handled. After reaching a value of eight, the frame counter may be reset back to a value of one, indicating the first frame of a super frame.

Generally, branch 502 may be handled only after branch 501 was handled, so if in one cycle a first frame of a super frame has been detected, there would be no decrease in frame sync score before setting the frame counter to one by branch 501. Also, the handling of the frame counter may be handled after branch 501 has been handled, so if there is a detection by branch 501, the counter may be already updated at the same cycle.

The above applies in coherent mode. When, however, working in a non-coherent mode of operation according to formula (3), the use of the TH2 test is meaningless, since there is no correlation cancellation between sync word W1 12 and W2 13 when W2 13 is received instead of W3 14, as in formula (4). Thus, using the non-coherent mode of operation by itself may not be used for full super frame synchronization. However, due to the fact that the non-coherent mode of operation is less vulnerable to frequency deviation, in cases where large frequency deviation is present, the circuit 200 and more particularly the CU 220 may nevertheless be configured to use the non-coherent mode of operation, in which full frame synchronization may be achieved. Since the Integrated Services Digital Broadcasting for Satellite (ISDB-S) transmission signal includes burst signals, also known as pilots, which are located in predetermined indexes for the aid of carrier recovery, a Frequency Lock Loop (FLL) module may use those bursts in order to reduce any frequency deviation. Nevertheless, since the pilot data is randomized before transmission, the receiver must first de-randomize the pilot data in order to use it in the FLL, and in order to do that an initial frame synchronization must first be achieved.

In view of the above, one way of operating the system when large frequency shift exists, is to initially operate circuit 200 in the non-coherent correlation mode, which is less vulnerable to the frequency shift, and arrive at an initial frame sync. With the initial frame synchronization the FLL may then decrease the frequency residue up to a level in which the circuit 200 can work in coherent correlation mode. Once coherent mode is achieved then it is possible to also obtain super frame sync.

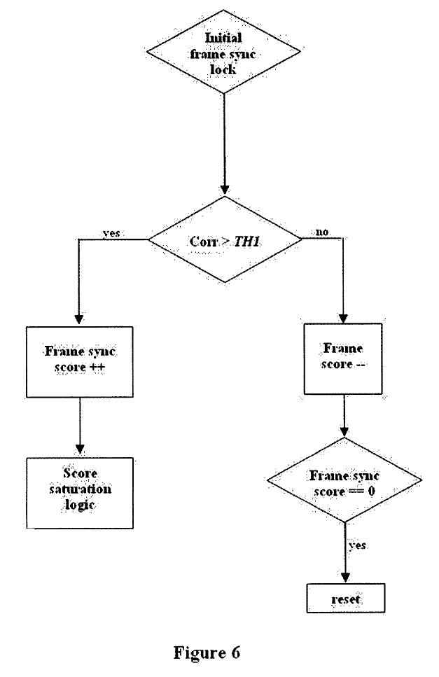

The non-coherent algorithm is now described with respect to FIG. 6. As shown in FIG. 6, the non-coherent process may begin after initial lock by the MD 230. The comparison of the correlation output to TH1 may result in increasing or decreasing the frame sync score, without any dependency on frame_counter, since the non-coherent correlation of the last symbol of the second unique word is expected to be high for all frames of all super frames. If the frame sync score reaches a predetermined level, no further increase is needed. If the frame sync score reaches zero, a reset may be declared.

The output of the circuit 200, that is Data_out 202, may be generated by the LU 210 and may contain the original input data to the circuit 200, Data_in 201, to which has been added an additional bit which indicates the first symbol of each frame if set to one (frame_sync_flag). In the case of super frame synchronization another additional bit may be added which indicates the first symbol of a super frame if set to one (super_frame_sync_flag). Frame_sync_flag may be set to one each time the index of an input symbol equals the index of the last symbol of the sync word W2 13 or W3 14 minus 191, which is the symbol distance from the first symbol of the frame to the last symbol of the second sync word. Super_frame_sync_flag may be set to one each time frame_sync_flag is set to one and also frame_counter equals one, indicating the first frame of a super frame.

It is expected that during the life of a patent maturing from this application many relevant correlation methods will be developed and the scope of the term correlation is intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. Apparatus for frame synchronization in a broadcast receiver where received frames comprise first and second synchronization words at predetermined locations in the frame, the apparatus comprising:
a correlator set with expected synchronization words for correlation with incoming symbols of said frame, to find probable locations of said first and second synchronization words within said frame, and
a thresholder for thresholding said correlation according to both said first and second synchronization words, thereby to allow said receiver to synchronize with said frame.

2. The apparatus of claim 1, wherein said thresholder is associated with a maximizer configured to determine index positions giving maximum correlation values over a series of frame lengths.

3. The apparatus of claim 1, wherein said second synchronization word takes first and second values within said frames depending on whether a given frame is a first frame of a super frame or not, said second value being a complement of said first value so as to give minimal correlation when said first value gives maximal correlation, said thresholder being set with an upper threshold to recognize said maximal value and a lower threshold to recognize said minimal value, thereby to distinguish using correlation between frames and super frames, and allow said apparatus to further synchronize with said super frames.

4. The apparatus of claim 1, wherein said correlator is a non-coherent correlator configured to calculate separate correlations for each of said first and second word, taking into account a time delay therebetween, and to add said separate correlations.

5. The apparatus of claim 1, wherein said correlator is a coherent correlator, configured to compute a single correlation result from both of said first and second words together, taking into account the time delay between them.

6. The apparatus of claim 1, wherein said correlator is controllably configurable via a control signal to be either a non-coherent correlator, configured to calculate separate correlations for each of said first and second word, taking into account a time delay therebetween, and to add said separate correlations, or a coherent correlator, configured to compute a single correlation result from both of said first and second words together, taking into account the time delay between them.

7. The apparatus of claim 6, further comprising a frequency lock loop circuit, and wherein during a frequency shift condition, the control signal is usable to switch said correlator between an initial non-coherent state wherein the frequency lock loop circuit operates to reduce said frequency shift, and a subsequent coherent state.

8. Apparatus according to claim 3, further comprising a frame counter and a super frame counter, said frame counter for incrementing when an expected frame synchronization is confirmed and decremented when an expected frame synchronization is missed, and said super frame counter for incrementing when an expected super frame synchronization is confirmed and decremented when an expected super frame synchronization is missed, thereby to provide numerical indicators of a current reliability of synchronization.

9. The apparatus of claim 1, wherein said maximizer is configured to generate a control signal holding a symbol index in response to a correlation result.

10. The apparatus according to claim 1, wherein said maximizer is configured to determine an index with a maximum correlation value over a series of constant frame lengths over the input data, said series comprising a predetermined number of frame lengths.

11. The apparatus according to claim 10, further comprising a control input to said maximizer to define for said maximizer said predetermined number.

12. The apparatus of claim 3, comprises a synchronization flag inserter, configured to inject, to the input signal, frame sync and super frame sync flags, therewith to allow said apparatus to synchronize with said frames and said super frames.

13. The apparatus according to claim 12, wherein said frames are frames according to the Integrated Services Digital Broadcasting for Satellite (ISDB-S) system, each containing first and second synchronization words of 20 symbols with a predetermined distance between them.

14. The apparatus according to claim 3, wherein said thresholder compares a correlation value to a first threshold and a second threshold, and produce a HIT and MISS signals for each threshold.

15. The apparatus according to claim 14, wherein the frame counter is configured to produce an increment if the correlation value crosses said first threshold, and a decrement otherwise, and the super frame counter is configured to produce a decrement if crossing the second threshold and an increment otherwise.

16. The apparatus according to claim 14, wherein said comparing is carried out only when an input index equals an index reported by the maximizer.

17. The apparatus according to claim 14, further comprising a control input for setting said first and second thresholds.

18. The apparatus according to claim 12, wherein said flag inserter is configured to set an output frame sync flag to one at the index of a first symbol of each frame and reset at any other index.

19. The apparatus according to claim 12, wherein said flag inserter is configured to set an output super frame sync flag to one at the index of the first symbol of each super frame and reset at any other index.

20. The apparatus according to claim 13, further configured to calculate an index of the first symbol of each frame by subtracting said predetermined length from an output index of the maximizer circuit, said output index being an index of the last symbol of the second synchronization word.

21. The apparatus according to claim 14, wherein said flag inserter is configured to produce respective output frame sync flags and super frame sync flags in response to said HIT and MISS signals and maximum frame and super frame synchronization score parameters.

22. The apparatus according to claim 4, wherein said non-coherent correlator is configured to calculate a non-coherent correlation according to:
$${R}_{n} = {( {\sum }_{i = 0}^{19} {SI}_{n - i - 160} \cdot W {1}_{19 - i} )}^{2} + {( {\sum }_{i = 0}^{19} {SQ}_{n - i - 160} \cdot W {1}_{19 - i} )}^{2} + {( {\sum }_{i = 0}^{19} {SI}_{n - i} \cdot W {3}_{19 - i} )}^{2} + {( {\sum }_{i = 0}^{19} {SQ}_{n - i} \cdot W {3}_{19 - i} )}^{2}$$
Where SIₙ comprises the in-phase component of the n^{th} input symbol, SQₙ comprises the quadrature component of the n^{th} input symbol, W1ₙ comprises the n^{th} BPSK modulated value of the first synchronization word, and W3ₙ comprises the n^{th} BPSK modulated value of the second synchronization value of the second synchronization word.

23. The apparatus according to claim 5, wherein the coherent correlator is configured to calculate said coherent correlation according to:
$${R}_{n} = {( {\sum }_{i = 0}^{19} {SI}_{n - i - 160} \cdot W {1}_{19 - i} + {\sum }_{i = 0}^{19} {SI}_{n - i} \cdot W {3}_{19 - i} )}^{2} + {( {\sum }_{i = 0}^{19} {SQ}_{n - i - 160} \cdot W {1}_{19 - i} + {\sum }_{i = 0}^{19} {SQ}_{n - i} \cdot W {3}_{19 - i} )}^{2}$$
Where SIₙ comprises an in-phase component of the n^{th} input symbol, SQₙ comprises the quadrature component of the n^{th} input symbol, W1ₙ comprises the n^{th} BPSK modulated value of the first synchronization word, and W3ₙ comprises the n^{th} BPSK modulated value of the second synchronization value of the second synchronization word.

24. A method for frame synchronization in a broadcast receiver where received frames comprise first and second synchronization words at predetermined locations in the frame, the method comprising:
using expected synchronization words for correlation with incoming symbols of said frame, to find probable locations of said first and second synchronization words within said frame, and
thresholding said correlation according to both said first and second synchronization words, thereby to allow said receiver to synchronize with said frame.

25. The method of claim 24, comprising calculating separate correlations for each of said first and second word, taking into account a time delay therebetween, and adding said separate correlations.

26. The method of claim 24, comprising computing a single correlation result from both of said first and second words together, taking into account the time delay between them.

27. The method of claim 24, wherein said correlating is controllably configurable via a control signal to be either non-coherent correlating, comprising calculating separate correlations for each of said first and second word, taking into account a time delay therebetween, and adding said separate correlations, or coherent correlating, comprising computing a single correlation result from both of said first and second words together, taking into account the time delay between them.

28. The method of claim 27, comprising during a frequency shift condition, switching said correlating between an initial non-coherent state and a subsequent coherent state.

29. The method of claim 28, comprising using frequency locking during said non-coherent state to reduce said frequency shift to allow commencement of said coherent state.

30. The method of claim 27, wherein said coherent correlation comprises:
initializing to coherent correlation after determining an index of the symbol having the maximum correlation value over a frame, Iₘₐₓ (“initial lock”);
Initializing frame_counter, frame_sync_score, super_frame_sync_score and super_frame_sync_lock parameters to zero;
Checking if said super_frame_sync_lock equals zero and if frame_counter is less than 2:
if so—checking if the correlation value is smaller than a second threshold:
If so—increasing said super_frame_sync_score by one and setting said frame_counter to one;
If not—setting super_frame_sync_score to zero and setting frame_counter to zero;
If said super_frame_sync_score equals MAX_SFSS then setting super_frame_sync_lock to one;
Checking if the correlation value is greater than first threshold:
If so—increasing frame_sync_score by one, and if the resulting new value of frame_sync_score is greater than MAX_FSS then setting frame_sync_score to MAX_FSS,
If the correlation value is not greater then the first threshold—checking if super_frame_sync_lock equals one and frame_counter also equals one:
If either super_frame_sync_lock or frame_counter do not equal one then—decreasing frame_sync_score by one and checking if the new value of frame_sync_score equals zero;
if said frame_sync_score equals zero then declaring that lock has been lost and resetting the process;
Checking if said frame_counter is greater than zero:
If said frame-counter is greater than zero then—increasing the frame_counter by one; if the frame_counter is greater than eight then setting the frame_counter to one; and
returning to check the next correlation value against said first threshold.

31. The method of claim 27 wherein said non-coherent correlation comprises: initializing the correlation state after determining the index of the symbol having the maximum correlation value over a frame, Iₘₐₓ (“initial lock”);
Initializing a frame_sync_score to zero;
checking if a current correlation value is greater than a first threshold:
If so—increasing frame_sync_score by one, and if a resulting value of frame_sync_score is greater than MAX_FSS then setting frame_sync_score to MAX_FSS;
If the current correlation value is less than said first threshold—decreasing said frame_sync_score by one and checking if the new value of frame_sync_score equals zero, thereby to reset the process; and otherwise returning to check the following correlation value against said first threshold.
